(19) United States
(12) Patent Application Publication
(10) Pub. No.: US 2008/0204989 A1
(43) Pub. Date: Aug. 28, 2008

(54) Fastening device

(76) Inventor: Chien-Da Hu, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/711,712

(22) Filed: Feb. 28, 2007

(51) Int. Cl. G11B 33/02

(52) U.S. Cl. 361/683

(57) ABSTRACT

A fastening device includes an assembling portion, a fastener, at least one flexible element, and a key. The assembling portion has an operational hole, a first plugging hole, a through hole, and a second plugging hole. The fastener is located on the outside surface of the assembling portion, and includes an opening hole that corresponds to the operational hole, at least one first flexible arm is positioned in the first plugging hole, at least one second flexible arm is positioned in the second plugging hole, and at least one short rod passes through the through hole. The flexible element is located between the assembling portion and the fastener. The key is located on the outside surface of the fastener and extends into the operational hole for controlling the relative movement between the fastener and the assembling portion so that the short rod fastens or withdraws the object.

### BACKGROUND OF THE INVENTION

1. Field of the Invention

The present invention relates to a fastening device. In particular, this invention relates to a fastening device that can easily position a data accessing device. By pressing a key, the data accessing device can be fastened to and taken off from the fastening device. When the data accessing device is removed, the fastening device does not need to be installed.

2. Description of the Related Art

Data accessing devices used in personal computers, such as hard drives, floppy disk drives, and optical disk drives etc, are screwed to the corresponding screw holes located on the data accessing devices with a frame of the personal computer via screws.

However, when the data accessing device is disassembled from the personal computer, an auxiliary tool, such as a screwdriver, is required. It is complex and inconvenient. Especially, when the data accessing device is installed on the personal computer for a long time and the data accessing device is damaged, it is difficult to uninstall the data accessing device. It is time-consuming. When the data accessing device is uninstalled from the personal computer, the screws are easily lost so that the data accessing device cannot be installed again.

In order to overcome the above problem, Taiwan patent T.W. 090219111, “fastening device for data accessing device”, was proposed. There are two through holes on a side wall of a frame. A fastener includes a pressing portion. Two ends of the fastener individually and outwardly bend twice to form a first connecting portion and a second connecting portion. The end of each second connecting portion is individually and inwardly bended to form two fastening arms. There is a wedge on one end of the fastening arm.

By plugging the wedge through the corresponding through hole of the side wall of the frame and being received in the screw hole of the side wall of the data accessing device, the data accessing device is fastened on the frame.

However, the fastening device has many drawbacks:

1. The fastening device of the prior art utilizes a wedge located on the end of the fastening arm to replace the screws to position the data accessing device. The screws are not required. However, when the data accessing device is damaged and needs to be replaced or maintained, the user or the maintenance staff needs to take the fastener from the frame so that the data accessing device can be removed. Because the fastener is small and has been removed from the frame, it is easily lost and damaged. Furthermore, because the fastener fits in the hole of the frame, the fastener cannot be replaced by a different fastener. If the fastener is lost or damaged, the data accessing device cannot be installed.

2. After the data accessing device has been uninstalled and reinstalled, the user needs to align the wedge with the through hole located on the side wall of the frame to reinstall the fastener to the frame and fasten the data accessing device. It is complex.

### SUMMARY OF THE INVENTION

One particular aspect of the present invention is to provide a fastening device. The fastening device easily positions a data accessing device. By pressing a key, the data accessing device can be removed from the fastening device. When the data accessing device is removed, the fastening device does not need to be installed.

The fastening device is located on a side wall of a frame for fastening an object. The fastening device includes an assembling portion located on the side wall of the frame, a fastener located on the outside surface of the assembling portion, at least one flexible element located between the assembling portion and the fastener, and a key located on the outside surface of the fastener. On a side surface of the assembling portion, there is at least one operational hole, at least one first plugging hole, at least one through hole, and at least one second plugging hole. The fastener has an opening hole that corresponds to the operational hole. At least one first flexible arm extends from the inside surface of the fastener, and passes through the first plugging hole and is positioned on the assembling portion. At least one second flexible arm extends from the inside surface of the fastener, and passes through the second plugging hole and is positioned on the assembling portion. At least one short rod extends from the inside surface of the fastener, and passes through the through hole for fastening the object. The key extends into the operational hole for controlling the relative movement between the fastener and the assembling portion so that the short rod fastens or withdraws the object.

Pushing the fastener near to the assembling portion makes the short rod move to and fasten the object and compress the flexible element. By pressing the key, the flexible element is released and the fastener is controlled to depart from the assembling portion so that the short rod withdraws the data accessing device.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an assembly perspective view of the present invention;

FIG. 2 is an exploded perspective view of the present invention;

FIG. 3 is another exploded perspective view of the present invention;

FIG. 4 is a cross-sectional view of the present invention;

FIG. 5 is a first cross-sectional view of the operation of the present invention; and

FIG. 6 is a second cross-sectional view of the operation of the present invention.

### DETAILED DESCRIPTION OF THE PREFERRED EMBODIMENTS

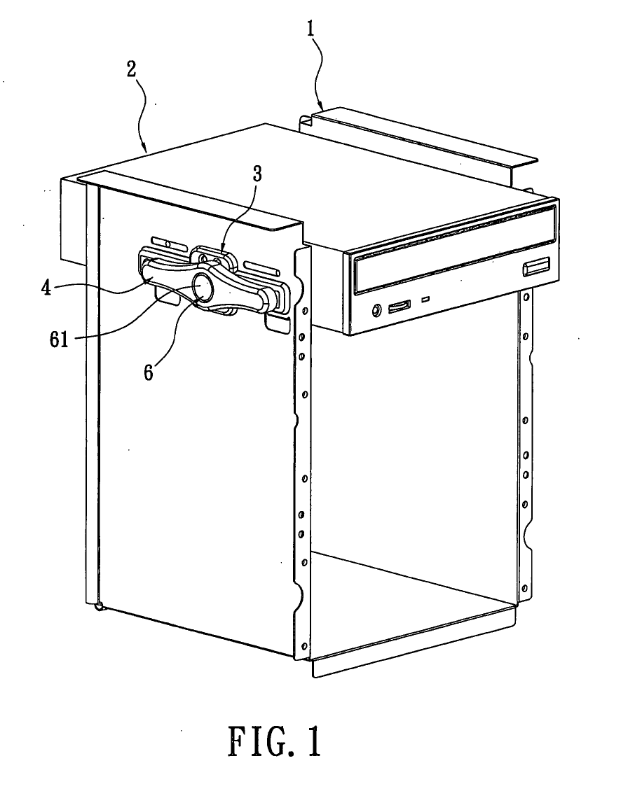

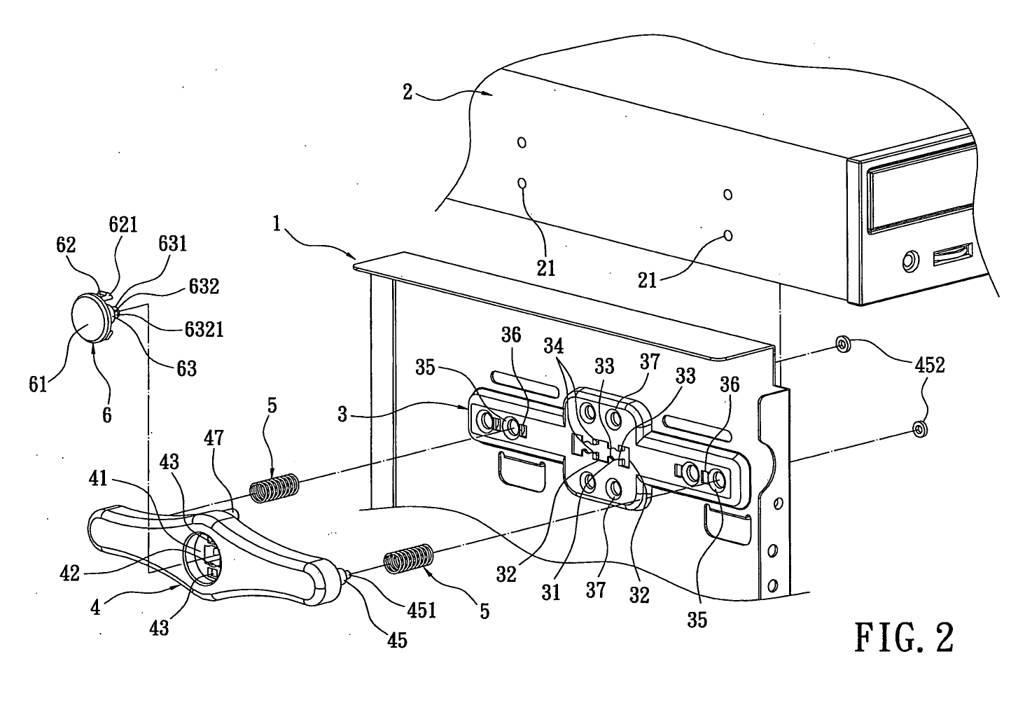

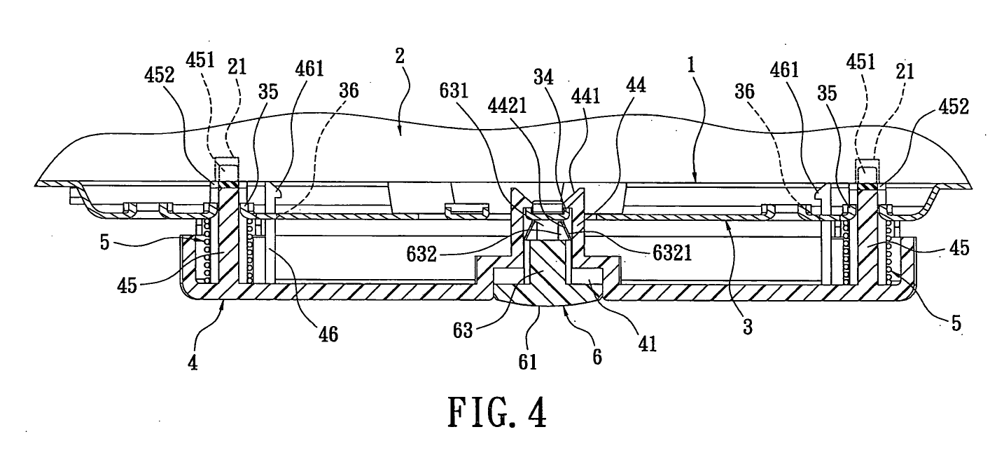

Reference is made to FIGS. 1, 2, 3 and 4. The fastening device is located on a side wall of a frame 1 for fastening a data accessing device 2. On the side wall of the data accessing device 2, there is a plurality of fastening holes 21. The fastening device includes an assembling portion 3, a fastener 4, two flexible and anti-compressing elements 5, and a key 6.

The assembling portion 3 extends from the side wall of the frame 1. Near to a center of the side surface of the assembling portion 3, there are two operational holes 31. On a side surface of the assembling portion 3 that corresponds to two sides of the operational holes 31, there is a first plugging hole 32. Two extending holes individually extend from the two sides of the operational hole 31 and pass through the first plugging hole 32. On an inside surface of the assembling portion 3 that is near to the side edge, there are two convex ribs 34. On an assembling portion 3 that corresponds to two sides of the operational holes 31, there are two through holes 35 and two second plugging holes 36 on each side. There are two positioning holes 37 that are near to the upper end and the lower end of the side surface of the assembling portion 3.

The fastener 4 is located on the outside surface of the assembling portion 3. There is a receiving slot 41 that is near to the center of the side surface of the fastener 4. There is an opening hole 42 in the receiving slot 41 of the fastener 4, and the opening hole 42 corresponds to the operational hole 31. In the receiving slot 41 of the fastener 4 that corresponds to two sides of the opening hole 42, there is a through hole 43. On two sides of the opening hole 42 on the inside surface of the fastener 4, there is a first flexible arm 44 that passes through the first plugging hole 32 of two sides of the operational hole 31. At an end of the first flexible arm 44, there is a first wedged block 441 that wedges the two convex ribs located on the inside surfaces of the assembling portion 3. A convex block 442 laterally extends from the first wedged block 441 and extends into the extending hole 33. At an end of the convex block 442, there is a slanting contacting surface 4421. Two short rods 45 extend from the inside surface of the fastener 4 that individually pass through the through hole 35. There is a plugging rod 451 with smaller diameter that extends from an end of the short rod 45, and the plugging rod 451 is plugged into the fastening hole 21 of the data accessing device 2. A rubber pad 452 is sleeved into the plugging rod 451 to reduce shock and increase the holding force for the data accessing device 2. Two second flexible arms 46 extend from the inside surface of the fastener 4, and the two second flexible arms individually pass through the second plugging hole 36. The second flexible arm 46 is longer than the first flexible arm 44. At an end of the second flexible arm 46, there is a second wedged block 461 that wedges the inside surface of the assembling portion 3. At an upper end and a lower end of the inside surface of the fastener 4, there is a positioning rod 47 that is plugged into the positioning hole 37 located on an upper end and a lower end of the assembling portion 3.

The two flexible and anti-compressing elements 5 are individually sleeved on the short rod 45. Two ends of the two flexible and anti-compressing elements 5 individually push the outside surface and the inside surface of the fastener 4.

The key 6 has a pressing button 61 received in the receiving slot 41 located on the outside surface of the fastener 4. On the inside of the pressing button 61, there are two third flexible arms 62 that pass through the two through holes 43. At an end of the third flexible arms 62, there is a third wedged block 621 that wedges the inside surface of the fastener 4 to restrict the key 6. There is a short column 63 extending from the inside of the pressing button 61, and the short column 63 passes through the opening hole 42 and the operational hole 31. There is a convex column 631 having a smaller diameter that extends from the front end of the short column 63. At two sides of the convex column 63, there is a pushing block 632 that respectively extends into the extending hole 33. There is a pushing surface 6321 formed at an end of the pushing block 632, and the pushing surface 6321 contacts and pushes the contacting surface 4421.

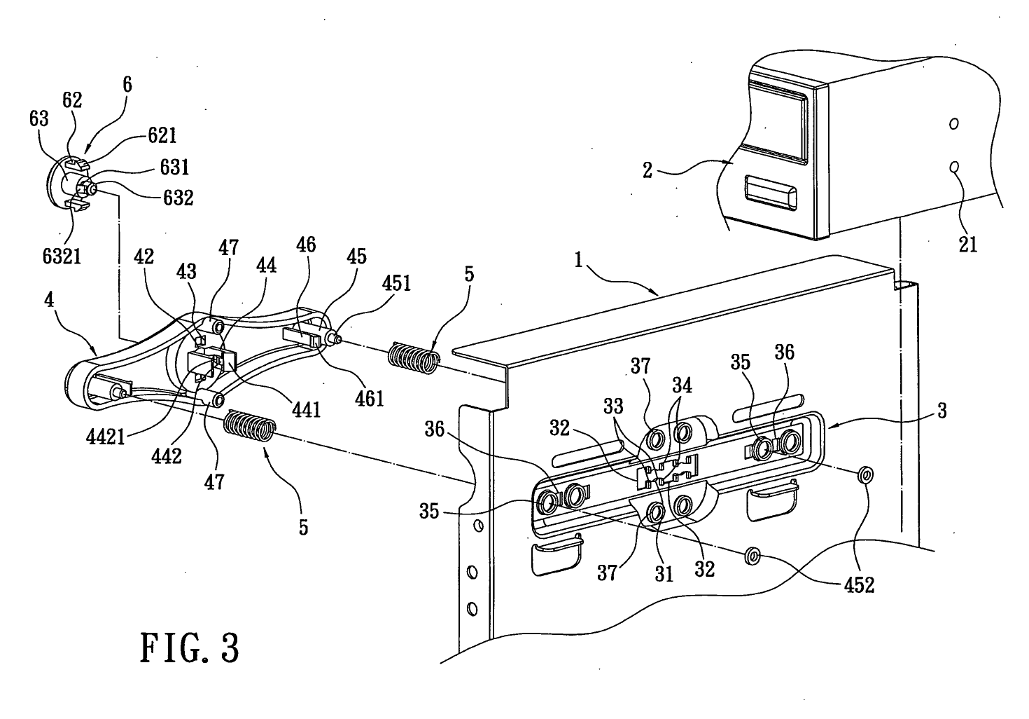

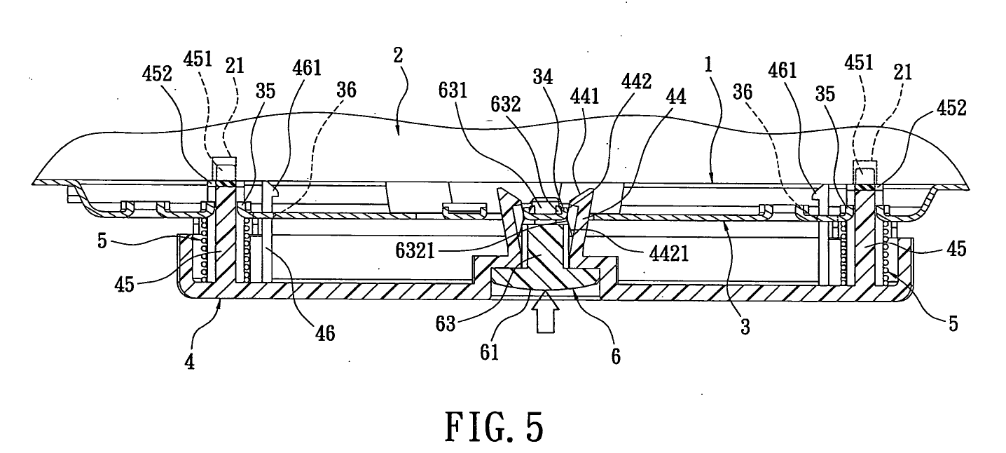

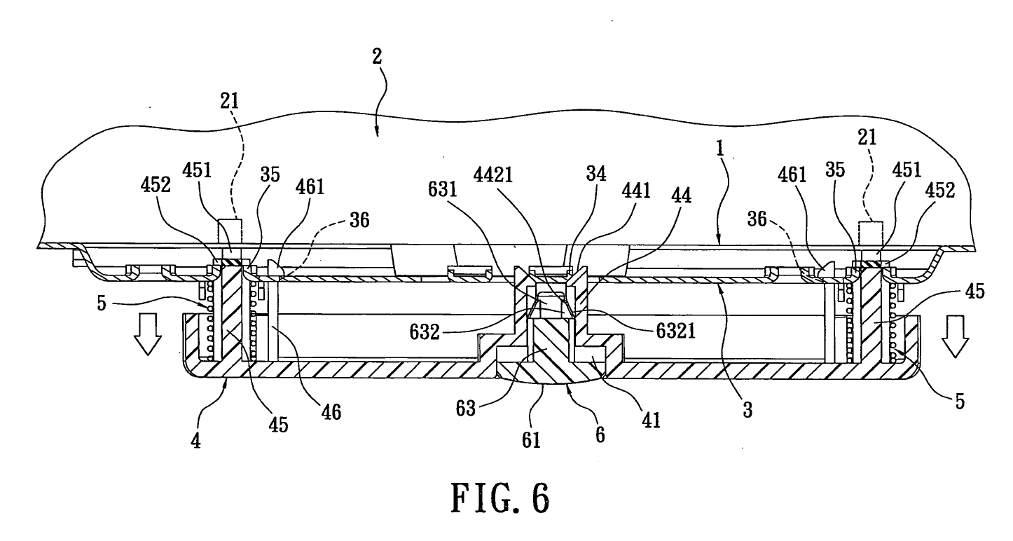

Reference is made to FIGS. 3, 4, 5 and 6. When the data accessing device 2 is assembled, the user installs the data accessing device 2 into the side wall of the frame 1. By pressing the pressing button 61 of the key 6, the short column 63 is pushed and moved so that the two pushing blocks 632 located at two sides of the convex column 63 individually extend into the extending holes 33. Thereby, the pushing surface 6321 of the pushing block 63 contacts and pushes the contacting surface 4421 of the convex block 44, and the fastener 4 moves forward to the assembling portion 3 to compress the flexible and anti-compressing element 5. The two short rods 45 individually pass through the through holes 35. The plugging rod located on the front end of the short rod 45 is plugged into the fastening hole 21 located on the side surface of the data accessing device 2 until the first wedged block 441 wedges into the inside surface of the assembling portion 3 to fasten the fastener 4. At this time, the fastening hole 21 located on the side surface of the data accessing device 2 is supported by the plugging rod 451 so that the data accessing device 2 is fastened.

The rubber pad 452 is sleeved on the plugging rod 451 so that the short rod 45 does not contact the outside wall of the data accessing device 2 and the rubber pad 452 prevents the outside wall of the data accessing device 2 from being damaged. When the user wants to withdraw the data accessing device 2, the user presses the pressing button 61 of the key 6 to move the short column 63. Thereby, the two pushing blocks 632 located on the two sides of the convex column 631 individually extend into the extending holes 33. The pushing surface 6321 of the pushing block 632 contacts and pushes the contacting surface 4421 of the convex block 442. The first flexible arm 44 is compressed and deformed so that the first wedged block 441 comes off from the first plugging hole 32. After the fastener 4 loses the support from the first wedged block 441 and is leased by the flexible and anti-compressing element 5, the fastener 4 withdraws from the outside surface of the assembling portion 3 so that the plugging rods 451 located at the front end of the two short rods 45 comes off from the positioning holes of the data accessing device 2 until the second wedged block 461 wedges into the inside surface of the assembling portion 3. At this moment, the positioning holes of the data accessing device 2 are not supported by the plugging rod 451 so that the data accessing device 2 can be removed from the frame 1.

In this embodiment, if the data accessing device 2 is too small and the two sides of the data accessing device 2 do not fit in with the side wall of the frame 1, a converting shell (not shown in the figure) is installed. There is also a plurality of fastening holes 21 located on the side wall of the converting shell for plugging with the plugging rod 451. Thereby, the converting shell is fastened and the data accessing device 2 in the converting shell is also positioned.

In the embodiment, the user can directly push the fastener 4 forwards to the assembling portion 3 to make the first wedged block 441 interfere with the first plugging hole 32. Thereby, the first wedged block 441 deforms until the first wedged block 44 wedges into the inside surface of the assembling portion 3 to fasten the fastener 4. When the fastener 4 moves, the flexible and anti-compressing element is also compressed to make the two short rods 45 individually pass through the through hole 35. The plugging rod 451 located at the front end of the short rod 45 is plugged into the fastening hole 21 located on the side surface of the data accessing device 2 to position the data accessing device 2.

In this embodiment, the frame 1 can be installed on the outside of the data accessing device 2, and can also be replaced by an auxiliary power module (not shown in the figures). Similarly, there is a plurality of fastening holes 21 located on the side wall of the auxiliary power module for being plugged with the plugging rod 451 to fasten the auxiliary power module.

The present invention has the following characteristics:

1. When the data accessing device 2 is installed, replaced, or maintained, the user does not need to remove or reinstall the fastener 4. By pressing a key 6 or directly pushing the fastener 4, the relative movement between the fastener 4 and the frame 1 is controlled. Thereby, the plugging rod 451 is plugged into the fastening hole 21 of the data accessing device 2, or withdrawn from the fastening hole 21. During the uninstalling and the installing process, the fastener 4 does not need to be uninstalled. It is easy, and the problem of the fastening being lost or damaged is avoided.

2. When the data accessing device 2 is uninstalled and reinstalled, the user does not need to uninstall the fastener 4. The assembling time is reduced and the assembling efficiency is improved.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A fastening device, located on a side wall of a frame for fastening an object, comprising:
an assembling portion located on a side wall of the frame, wherein there is at least one operational hole, at least one first plugging hole, at least one through hole, and at least one second plugging hole located on a side surface of the assembling portion;
a fastener located on an outside surface of the assembling portion, wherein the fastener has an opening hole that corresponds to the operational hole. At least one first flexible arm extends from the inside surface of the fastener, and passes through the first plugging hole and is positioned on the assembling portion, at least one second flexible arm extends from the inside surface of the fastener, and passes through the second plugging hole and is positioned on the assembling portion, and at least one short rod extends from the inside surface of the fastener, and passes through the through hole for fastening the object;
at least one flexible element located between the assembling portion and the fastener; and
a key located on an outside surface of the fastener and extending into the operational hole for controlling relative movement between the fastener and the assembling portion so that the short rod fastens or withdraws the object.

2. The fastening device as claimed in claim 1, wherein the first plugging holes are located on two sides of the operational hole of the assembling portion, an extending hole respectively extends from the two sides of the operational hole and passes through the first plugging hole, and at least one through hole and at least one second plugging hole are respectively located on the assembling portion that corresponds to the two sides of the operational hole; wherein there is a through hole located on at least one side of the opening hole of the fastener, the first wedged block laterally extends to form a convex block for extending into the extending hole, there is a first wedged block located at an end of the first flexible arm for wedging into the inside surface of the assembling portion, and there is a second wedged block located at an end of the second flexible arm for wedging into the inside surface of the assembling portion; wherein the key has a pressing button located on an outside surface of the fastener, there is at least one third flexible arm located on the inside surface of the pressing button and the third flexible arm passes through the through hole, there is a third wedged block located at an end of the third flexible arm for wedging into the inside surface of the fastener, a short column extends from inside of the pressing button and the short column passes through the opening hole and the operational hole, and there are two pushing blocks located on two sides of the short column and the pushing blocks extends into the extending holes for contacting and pushing the convex block.

3. The fastening device as claimed in claim 1, wherein there is a plugging rod with a smaller diameter extending from an end of the short rod, and the plugging rod is plugged into the fastening hole of the object.

4. The fastening device as claimed in claim 3, wherein the plugging rod is sleeved with a rubber pad.

5. The fastening device as claimed in claim 1, wherein there is at least one positioning hole located near to an upper end of a side surface of the assembling portion, and there is a positioning rod located on the inside surface of the fastener and the positioning rod corresponds to the positioning hole.

6. The fastening device as claimed in claim 1, wherein there is at least one positioning hole located near to a lower end of a side surface of the assembling portion, and there is a positioning rod located on the inside surface of the fastener and the positioning rod corresponds to the positioning hole.

7. The fastening device as claimed in claim 2, wherein there is a receiving slot located on the inside surface of the fastener and the receiving slot corresponds to the pressing button of the key, and the opening hole and the through hole are located in the receiving slot.

8. The fastening device as claimed in claim 2, wherein there is at least one convex rib located on a side edge of the first plugging hole of the inside surface of the assembling portion for wedging and positioning the first wedged block.

9. The fastening device as claimed in claim 2, wherein there is a convex column with a smaller diameter extending from a front end of the short column, and the pushing blocks are located at two sides of the convex column.

10. The fastening device as claimed in claim 1, wherein the assembling portion is formed by outwards extending from a side wall of the frame.

11. The fastening device as claimed in claim 2, wherein a slanting contacting surface forms at an end of the convex block, and a pushing surface is formed at an end of the pushing block and the pushing surface contacts and pushes the contacting surface.

12. The fastening device as claimed in claim 1, wherein the flexible element is a flexible and anti-compressing element.

13. The fastening device as claimed in claim 12, wherein the flexible element is sleeved on the short rod, and two ends of the flexible element individually contact and push an outside surface of the assembling portion and an inside surface of the fastener.

14. The fastening device as claimed in claim 1, wherein the second flexible arm is longer than the first flexible arm.

15. The fastening device as claimed in claim 1, wherein the object is a data accessing device, a converting shell, or an auxiliary power module.
